(19) United States
(12) Patent Application Publication
(10) Pub. No.: US 2025/0203500 A1
(43) Pub. Date: Jun. 19, 2025

(54) SLICE REGISTRATION AND PDU SESSION ESTABLISHMENT CONTROL

(71) Applicant: INTERDIGITAL PATENT HOLDINGS, INC., Wilmington, DE (US)

(72) Inventors: Michael Starsinic, Newtown, PA (US); Ulises Olvera-Hemandez, Saint-Lazare (CA); Samir Ferdi, Kirkland (CA); Anuj Sethi, Ottawa (CA); Saad Ahmad, Montreal (CA)

(73) Assignee: INTERDIGITAL PATENT HOLDINGS, INC., Wilmington, DE (US)

(21) Appl. No.: 18/851,392

(22) PCT Filed: Mar. 28, 2023
(86) PCT No.: PCT/US2023/016592

§ 371 Date: Sep. 26, 2024

Related U.S. Application Data
(60) Provisional application No. 63/324,354, filed on Mar. 28, 2022.
(60) Provisional application No. 63/338,688, filed on May 5, 2022.

(51) Int. Cl. H04W 48/18; H04W 60/00; H04W 76/12

(52) U.S. Cl. CPC H04W 48/18; H04W 60/00; H04W 76/12

(57) ABSTRACT

In some cases, a network may have restrictions on the number of connections that it can maintain (e.g., for a given area there may be a maximum capacity). Accordingly, there is a need to handle such restrictions in the most efficient manner possible such that devices wishing to connect or with current connections to the network are provided with the best possible chance of achieving their communication goals.

### CROSS-REFERENCE TO RELATED APPLICATIONS

This application claims the benefit of U.S. Provisional Application No. 63/324,354, filed Mar. 28, 2022, and 63/338,688, filed May 5, 2022, the contents of which are incorporated herein by reference.

### BACKGROUND

In some cases, wireless systems require constant improvement an modification in order to address new use cases and increase efficiency. In one specific area, there is a need for approaches that address network slice and packet data unit (PDU) management.

### SUMMARY

In some cases, a network may have restrictions on the number of connections that it can maintain (e.g., for a given area there may be a maximum capacity). Accordingly, there is a need to handle such restrictions in the most efficient manner possible such that devices wishing to connect or with current connections to the network are provided with the best possible chance of achieving their communication goals.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to one or more approaches described herein;

FIG. 1C is a system diagram illustrating an example radio access network (RAN) and an example core network (CN) that may be used within the communications system illustrated in FIG. 1A according to one or more approaches described herein;

FIG. 1D is a system diagram illustrating a further example RAN and a further example CN that may be used within the communications system illustrated in FIG. 1A according to one or more approaches described herein;

FIG. 2 illustrates an example of how to send a proactive indication to the WTRU;

FIG. 3 illustrates an example of a WTRU assisted PDU session early admission control flow; and

FIG. 4 illustrates an example of a WTRU process of receiving a network indicated replacement slice and managing related PDU session(s).

### DETAILED DESCRIPTION

One or more of the following acronyms may be used herein: Access and Mobility Function (AMF); Access Network (AN); Attention (AT); Early Admission Control (EAC); Mobility Management (MM); Mobile Termination (MT); Network Slice Admission Control Function (NSACF); Non-Access Stratum (NAS); Network Slice Selection Assistance Information (NSSAI); Protocol Data Unit (PDU); Performance Management Functionality (PMF); Registration Area (RA); Radio Access Network (RAN); Radio Resource Control (RRC); Route Selection Descriptor (RSD); Session Management (SM); Session Management Function (SMF); Single NSSAI (S-NSSAI); Slice-Specific Serving Area (SSAA); Tracking Area (TA); Terminal Equipment (TE); Unified Access Control (UAC); User Data Management (UDM); User Data Repository (UDR); User Equipment (UE); User Plane Function (UPF); and UE route selection policy (URSP).

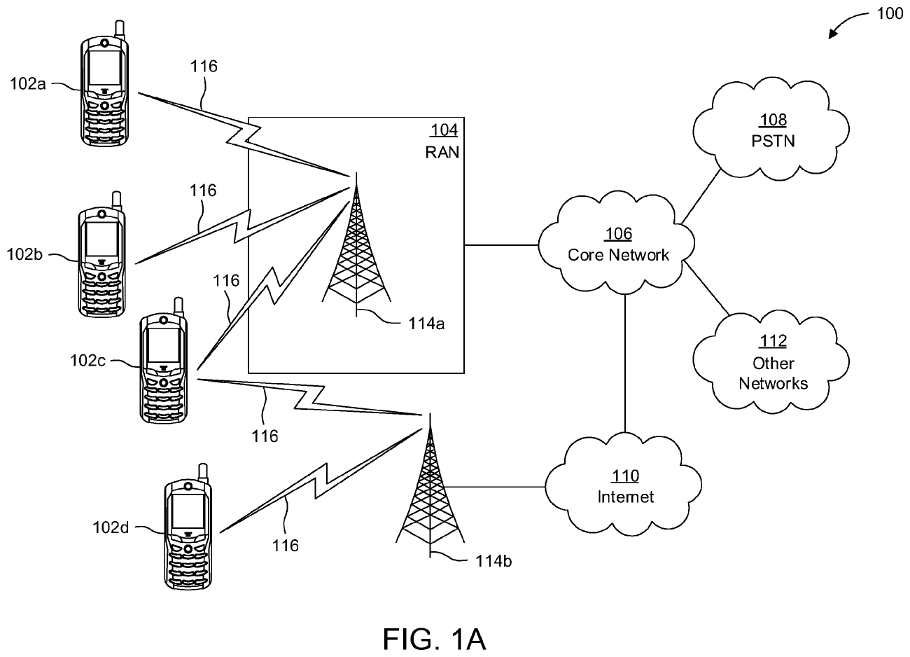

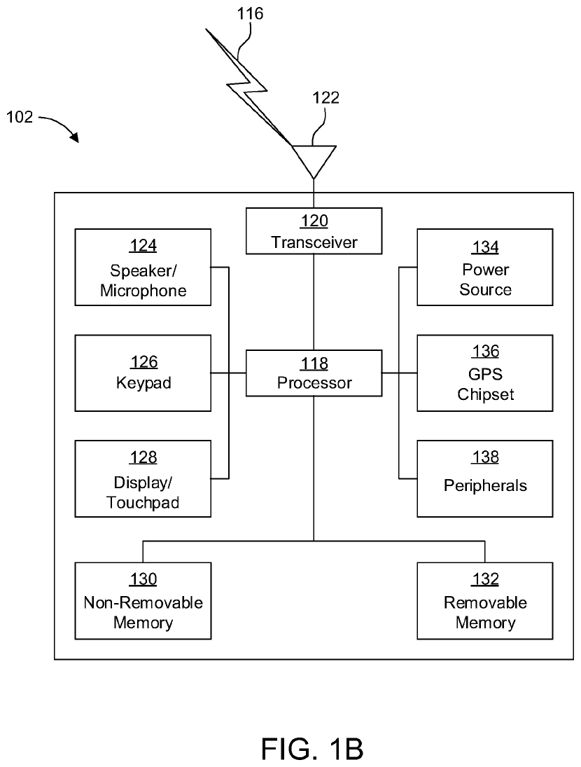

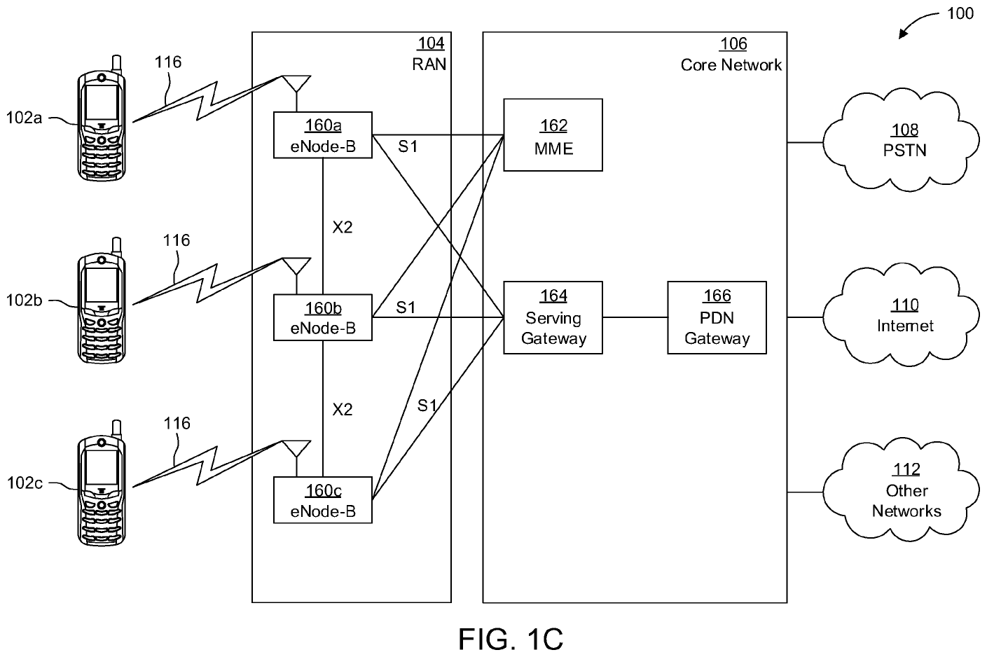

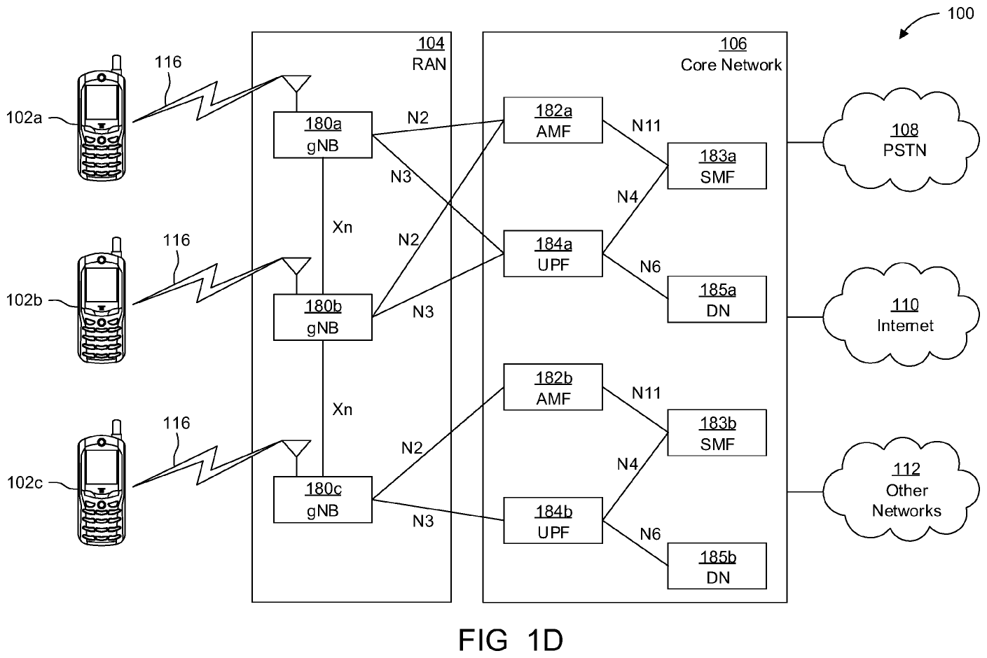

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHZ wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and Qos, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a- b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A Registration Area is a set of Tracking Areas. A Registration Area may be defined by a Tracking Area Identity (TAI) List (e.g., a list of tracking areas). When a WTRU registers with a network (e.g., sends a registration request to a network node, such as an AMF), the network (e.g., AMF) may allocate a registration area (e.g., the set of tracking areas in the TAI List) to the WTRU and may take information, such as the WTRU's expected mobility pattern, into consideration when allocating the TAI list.

A Configured Network Slice Selection Assistance Information (NSSAI) is a list, or collection, of one or more slices that a WTRU may access. The WTRU may receive a Configured NSSAI in a Registration Accept or WTRU Configuration Update message.

A Requested NSSAI is a list, or collection, of one or more slices that a WTRU sends to the network in order to request to register with the slices in the list. The WTRU may send a Requested NSSAI to the network in a Registration Request message.

An Allowed NSSAI is a list, or collection, of one or more slices that a WTRU may access in the WTRU's registration area. In other words, it is a list of slices that the WTRU may use in the WTRU's registration area.

A rejected Single-NSSAI (S-NSSAI) is an information element that the network may send to a WTRU in a Registration Accept or a WTRU Configuration Update message. A rejected S-NSSAI may indicate one or more slice that the WTRU included in a Requested NSSAI, but the network determined the WTRU may not access.

As disclosed herein, the phrases “attempting to register with a slice” and “including a slice (e.g., S-NSSAI) in a Requested NSSAI” may be used interchangeably. Additionally, the terms slice and S-NSSAI may be used interchangeably.

S-NSSAIs that the WTRU provides in the Requested NSSAI which are neither in the Allowed NSSAI nor provided as a rejected S-NSSAI, may, by the WTRU, not be regarded as rejected (e.g., the WTRU may request to register these S-NSSAls again next time the WTRU sends a Requested NSSAI).

When a WTRU is registered to a slice, it may use at least some minimal resources of the slice. For example, the WTRU may at least send periodic NAS messages to the AMF which is part of the slice. However, the WTRU may, or may not, use the user plane resources of the slice or other resources of the slice such as SMS and/or Location Services.

A WTRU may select up to 8 slices (e.g., S-NSSAIs) from its Configured NSSAI to register to. When a WTRU selects a slice(s) to register to, the WTRU will send a Registration Request to the network and the Requested NSSAI information element of the Registration Request will include the slice(s) that were selected for registration.

Various events may trigger the WTRU to send a register to a slice.

In one example of a trigger for registration, the WTRU may be configured to always attempt to register to certain slice(s) unless the WTRU knows that the slice is not available. For example, the WTRU may attempt to register to certain slice(s) immediately, or shortly after, power up.

In one example of a trigger for registration, the WTRU may be configured to attempt to register to certain slice(s) when registering in certain PLMNs.

In one example of a trigger for registration, the WTRU may be configured to attempt to register to certain slice(s) when one or more certain application traffic starts.

In one example of a trigger for registration, the WTRU may be configured to attempt to register to certain slice(s) when the WTRU is in a certain location.

In one example of a trigger for registration, the WTRU may be configured to attempt to register to certain slice(s) when certain applications are installed.

In one example of a trigger for registration, the WTRU may be configured to attempt to register to certain slice(s) when prompted by a user interface such a GUI. For example, a user may indicate, via GUI, that a certain service is desired.

Once a WTRU is registered to a slice, it may determine to establish a PDU Session in the slice. A WTRU may establish a PDU Session by sending a PDU Session Establishment Request to the network. A PDU Session Establishment Request is a NAS-SM message that may be sent to an SMF of the network slice that is associated with a network slice.

The PDU Session Establishment Request may include an S-NSSAI that is associated with the PDU Session and a Data Network Name (DNN) that is associated with the PDU Session. If an S- NSSAI is not included in the PDU Session Establishment Request, then the network may determine an S-NSSAI for the PDU Session. If a DNN is not included in the PDU Session Establishment Request, then the network may determine a DNN for the PDU Session.

Various events may trigger the WTRU to send a PDU Session Establishment Request to the network.

In one example of a trigger for PDU Session Establishment, a WTRU hosted application may request that the WTRU establish a PDU Session. The request from the WTRU hosted application may include a DNN and S-NSSAI and the WTRU may send the same DNN and S-NSSAI to the network in the PDU Session Establishment Request. For example, a WTRU that is hosted in a TE part of the WTRU may invoke an AT Command such as +CGDCONT (syntax used to request a PDU session or PDP Context) to request that the MT part of the WTRU send a PDU Session Establishment Request to the network (e.g., AT may be used to start a command line to be sent from the TE to the Terminal Adaptor).

In one example of a trigger for PDU Session Establishment, a WTRU hosted application may generate uplink traffic that causes the WTRU to evaluate UE Route Selection Policy (URSP) rules in order to determine desired characteristics for a PDU Session that will be used to send the uplink traffic to the network. The result of URSP evaluation may be that the WTRU determines to use an existing PDU Session or a new PDU Session to send the uplink traffic to the network. If the WTRU determines to establish a new PDU Session, then it will send a PDU Session Establishment Request to the network. The URSP Rules may also be used to determine what DNN and S-NSSAI to include in the PDU Session Establishment Request

In one example of a trigger for PDU Session Establishment, a WTRU may be configured with DNN/S-NSSAI combinations and the WTRU may always establish a PDU Session towards these DNN/S-NSSAI combinations when the WTRU is registered to the S-NSSAI in the combination. The WTRU may choose to establish these PDU Session(s) even if there are no WTRU Applications that will use the PDU Session(s) to send or receive traffic.

In one example of a trigger for PDU Session Establishment, the WTRU may receive device trigger that triggers the WTRU to establish a PDU Session. The device trigger may be a NAS or SMS message. The device trigger message may include the DNN and/or S-NSSAI that the WTRU may include in the PDU Session Establishment Request.

The Network Slice Admission Control Function (NSACF) monitors and controls the number of registered WTRUs per network slice and/or the number of PDU Sessions per network slice for the network slices that are subject to Network Slice Admission Control (NSAC). The NSACF may be configured with the maximum number of WTRUs and/or the maximum number of PDU Sessions allowed to be served per S-NSSAI subject to the NSAC. The NSACF may also be configured with information indicating applicable access type(s) for the S-NSSAI (e.g., 3GPP Access Type, Non-3GPP Access Type, or both). The NSACF may have hardware that is the same or similar to a WTRU, base station, network function network node, etc., as described herein; similarly, it may be run virtually from hardware that concurrently operates a different function.

The NSACF may keep track of the current number of WTRUs registered for a network slice so that it can ensure it does not exceed the maximum number of WTRUs allowed to register with the network slice.

The AMF may trigger a request to NSACF for NSAC for a maximum number of WTRUs when the WTRU's registration status for a network slice subject to NSAC is changing (e.g., during the WTRU Registration, WTRU Deregistration procedure, Network Slice-Specific Authentication and Authorization procedure, AAA Server triggered Network Slice-Specific Re-authentication or Re-authorization procedure, AAA Server triggered Slice-Specific Authorization Revocation procedure, and/or WTRU Configuration Update procedure).

When the maximum number of registrations for a slice has been reached, the NSACF may indicate to the AMF that a request to register to a slice should be rejected and a cause code may be provided to the WTRU that indicates that the slice registration was rejected because the maximum number registrations for the slice has been reached. A back-off timer may also be sent to the WTRU and the back-off timer may be used by the WTRU to detect when the WTRU may again try to register to the slice.

The NSACF may keep track of the current number of PDU Sessions per network slice so that it can ensure it does not exceed the maximum number of PDU session allowed to be served by the network slice. When an event related to a WTRU causes the current number of PDU sessions established within the network slice to increase, the NSACF may check whether the maximum number of PDU sessions per network slice for that network slice has already been reached, and if it has, the NSACF may apply admission control policies.

When the maximum number of PDU Sessions for a slice has been reached, the NSACF may indicate to the SMF that a PDU Session Establishment Request should be rejected and a cause code may be provided to the WTRU that indicates that the PDU Session was rejected because the maximum number of PDU Sessions for the slice has been reached. A back-off timer may also be sent to the WTRU and the back-off timer may be used by the WTRU to detect when the WTRU may again try to establish a PDU Session in the slice.

The anchor SMF triggers a request to NSACF for a maximum number of PDU sessions per network slice control during PDU session establishment/release procedures.

For a given wireless system (e.g., a 5G System), Unified Access Control (UAC) is where a WTRU is able to determine whether or not a particular new access attempt is allowed based on barring parameters that are broadcasted by the base station and based on information (e.g., Access Category and Access Identity Information) that is configured in the WTRU. UAC cannot be used to selectively bar WTRUs that are not sufficiently utilizing the resources of a slice or a PDU Session.

An AMF may be configured to perform Early Admission Control (EAC), as follows: The configuration for Early Admission Control (EAC) update procedure may indicate to the AMF the activation or the deactivation of the EAC mode for the S-NSSAI subject to NSAC. EAC mode means that the AMF is required to perform the number of WTRUs per network slice availability check and update procedure before the S-NSSAI subject to NSAC is included in the Allowed NSSAI and sent to the WTRU. EAC mode may only be applicable in the AMF when the update flag is set to increase.

As described in the examples above, a WTRU may sometimes register to a slice because some condition has been met (e.g., power on or application installation, etc.), however, the WTRU might not actually be using the resources of the slice beyond NAS messaging. For example, the WTRU might not establish a PDU Session in the slice. Such a WTRU may stay registered for a long period of time before ever establishing a PDU Session, sending a PDU/Packet, etc. In terms of management of network resources, this type of behavior may lead to inefficient and/or unfair allocation of resources in the network and is therefore not desirable. As explained earlier, the number of WTRUs that may register to the network slice may be limited by a NSACF. It would be inefficient use of network resources if a WTRU, which was not using resources of the slice beyond what is necessary to maintain a NAS connection with the AMF, was counted against a slice's registration quota. As an example, this may result in a second WTRU's registration request for that slice to be rejected when the registration quota is reached even though of the second WTRU wishes to actually use the slice for communication. There is a need for approaches that allow the network the ability to detect when a WTRU is not making good use of the resources of a network slice so that the WTRU can be de-registered from the slice. Another system inefficiency may stem from a sub-optimal selection of the serving AMF and Registration Area, for a WTRU that registers to one or more slices without using the slice for communication afterwards.

Similarly, as described in the examples above, a WTRU may sometimes establish a PDU Session because some condition has been met (e.g., a request from an application), however, the WTRU might not actually be using the PDU Session. For example, the WTRU might establish a PDU Session and go for a long period of time before using the PDU Session to send or receive data or not use the PDU Session to send and receive data at all. In terms of management of network resources, this type of behavior is not desirable. As an example, this may result in a second WTRU's PDU Session Establishment request for that slice to be rejected when the PDU Session quota is reached even though of the second WTRU wishes to actually use the PDU Session for communication. As explained earlier, the number of WTRUs that may establish a PDU Session in a network slice may be limited by a NSACF. It would be an inefficient use of network resources if a WTRU, which was not using an established PDU Session, was counted against a slice's PDU Session quota. There is a need for one or more approaches that allow the network the ability to detect when a WTRU is not making good use of a PDU Session so that the PDU Session can be terminated.

In order to address the aforementioned issues, and others, approaches may be described herein that provide solutions to these problems, and others. Further, these techniques may be used to further address problems that exists in existing wireless systems (e.g., 5G systems), as well as other wireless systems. Such approaches may enable the wireless systems to operate more efficiently, use less power, operate at greater speeds, operate at greater capacity, and the like.

As described above, when the WTRU attempts to establish a PDU Session, the PDU Session Request may be rejected and a cause code may be sent to the WTRU that indicates that the PDU Session Establishment Request was rejected because the maximum number of PDU Sessions has been reached.

It may be advantageous to indicate to the WTRU when a slice has reached its PDU Session limit. For example, the network may send this indication to the WTRU when sending a NAS Message to the WTRU such as a Registration Accept message or a WTRU Configuration Update Message. By providing this indication to the WTRU proactively, undesired PDU Session Establishment Requests may be avoided.

In addition, the network may extend the EAC (Early Admission Control) concept to include PDU Session Admission control. Thus, the NSACF may configure the SMF to activate EAC also for PDU Sessions assigned to S-NSSAls, referred to herein as P-EAC. The SMF may subscribe to P-EAC notifications, such as when it performs the first network slice availability check and update procedure. The NSACF may set thresholds to trigger the activation or deactivation of P-EAC in the SMF. These thresholds may be set based on WTRU related analytics or Network Slice Load Analytics. For example, WTRU Communications Analytics and Expected WTRU behavior analytics, such analytics may be requested for specific PDU Sessions, when the WTRU is a particular location and at a particular time. These analytics may include Session Inactivity time, as well as application traffic start and stop time, and predictions on the number of WTRUs and PDU session associated to an S-NSSAI, which can be used by the NSACF to set this threshold.

When the SMF is configured with P-EAC (e.g., when the NSACF sends a EAC Notification to the SMF), the SMF may perform a “number of PDU Sessions per network slice availability check” operation, if the P-EAC flag is activated, before the SMF accepts the establishment of the PDU Session (e.g., after the successful DN authentication/authorization or if no PDU Session Authentication/Authorization is required) after the PDU Session context is created.

The SMF may use the P-EAC notification from the NSACF and it may provide an early indication to the WTRU (e.g., providing a grace period, within the PCO (Protocol Configuration Options) Information Element (IE), or a dedicated IE) of a PDU Session Modification Command that a PDU Session limit is likely to be reached. In addition, the SMF may use information from the NSACF to provide the WTRU with an indication as to what S-NSSAI the PDU Session may be moved to before the grace period expires. This could be done by providing a new Configured NSSAI with marked S-NSSAIs.

The WTRU may use some indication, such as the indication that the PDU Session limit has been reached or a P-EAC indication, to move PDU Sessions to either a different S-NSSAI or, if an additional Access Network (AN) is available and the EAC is not applicable to this additional AN (e.g., the EAC is applicable to 3GPP AN but not to a non-3GPP access network). The WTRU may move the PDU Sessions to a different access network. For example, the WTRU may move the PDU Sessions from a first S-NSSAI/AN combination to a second S-NSSAI/AN combination where the S-NSSAI of both the first and second combinations are the same. This may be done because AN of the second combination does not have a restriction.

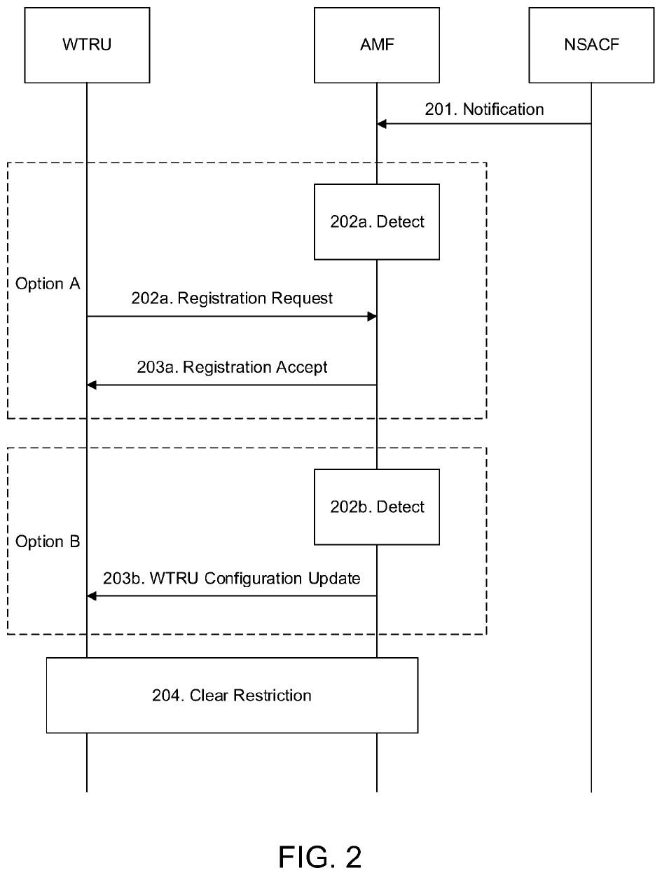

FIG. 2 illustrates an example of how to send a proactive indication to the WTRU (e.g., regarding a PDU session or a slice), such as described herein. As shown, at 201, the AMF may receive a notification from the NSACF that a slice (e.g., identified by an S-NSSAI) has reached its PDU Session limit. The AMF may notify the WTRU that a slice (e.g., identified by an S-NSSAI) has reached its PDU Session limit when the AMF responds to a Registration Request from the WTRU. For example, the AMF may choose to wait to notify the WTRU until the WTRU enters connected mode by sending a registration request. Alternatively, the AMF may notify the WTRU that a slice (e.g., identified by an S-NSSAI) has reached its PDU Session limit by sending a WTRU Configuration Update message to the WTRU. For example, the AMF may choose to send the WTRU Configuration Update message to the WTRU if the WTRU is already in connected mode or the AMF may choose to initiate a paging procedure for the WTRU if the WTRU is in idle mode so that the AMF can send the WTRU Configuration Update message to the WTRU. These different example scenarios are shown as different options in the figure.

At 202a, the WTRU may send a Registration Request to the AMF. For example, this registration request may be a Mobility Registration Update. The AMF may detect that the S-NSSAI that was identified at 201 as having reached its PDU Session limit is in the WTRU's Requested NSSAI.

At 203a, the AMF sends a Registration Accept message to the WTRU. The Registration Accept message includes an indication that the S-NSSAI has reached its PDU Session limit and, in some instances, an associated back-off timer. The indication signals that the WTRU is barred from attempting to send a PDU Session Establishment Request for the slice until the associated back-off timer expires or until the restriction is cleared. Existing PDU Session(s) may be maintained. If the Registration Accept Message includes an indication that the maximum number of WTRUs per network slice has been reached, the AMF may send a list of S-NSSAI, in the Configured NSSAI, that the WTRU may use when attempting a new Registration (e.g., mobility registration). Some approaches may use a network slice transfer mechanism for a WTRU to move PDU Sessions to a target slice when a maximum number of WTRUs for the slice is reached, however, this is an area that needs improvement because there are legacy wireless system designs that have no mechanism for how the target slice is selected (e.g., among several). For instance, the network (e.g., the AMF) may provide a list of target S-NSSAI, in the Configured NSSAI, and the WTRU may choose based on its needs. If the network wants to enforce specific network slices as the target, the network may mark those S-NSSAIs within the Configured NSSAI.

At 202b, the AMF may detect that a WTRU is registered to the S-NSSAI that was identified at 201 as having reached its PDU Session limit is in the WTRU's Allowed NSSAI.

At 203b, the AMF may send a WTRU Configuration Update message to the WTRU. The WTRU Configuration Update message may include an indication that the S-NSSAI has reached its PDU Session limit and, in some instances, an associated back-off timer. The indication signals that the WTRU is barred from attempting to send a PDU Session Establishment Request for the slice until the associated back-off timer expires or until the restriction is cleared. Existing PDU Session(s) may be maintained.

At 204, the restriction may be cleared by the network (e.g., before the back-off timer expired). The restriction may be cleared by the AMF sending the WTRU a NAS message, such as a Registration Accept or WTRU Configuration Update with no indication that the S-NSSAI has reached its PDU Session limit, an indication that the S-NSSAI has reached its PDU Session limit with no back-off timer, or an indication that explicitly indicates that the restriction has been removed.

Alternatively, the indication from the NSACF at 201 may have indicated to the AMF that the slice is approaching its PDU Session that all, or a certain one or more, WTRUs will be limited in terms of the number of PDU Session that they establish within the slice.

The Registration Accept message at 203a or the WTRU Configuration Update message of at 203b, may be used by the AMF to indicate to the WTRU that the WTRU is restricted in terms of the number of PDU Session(s) that it may establish in the slice. The AMF may also provide the WTRU with the limit value (e.g., an integer value) and, in some instances, a back-off timer that may be used to determine when the restriction can be considered removed, and possibly a list (e.g., map) of slice replacements, as described herein. Also, as described above, the restriction may also be removed via an indication from the AMF.

When the network has indicated to the WTRU that a slice has reached its PDU Session Limit, the WTRU may behave differently when evaluating URSP Rules. For example, if a back-off timer that is associated with the Slice's PDU Session Limit indication is still running (e.g., the restriction has not been removed), the WTRU may consider all Route Selection Descriptors (RSD) that include the S-NSSAI to be invalid until the back-off timer expires or the restriction has been removed. In another example, if the WTRU received an EAC indication for an S-NSSAI, then the WTRU may consider all RSD that include the S-NSSAI to be invalid or lower in priority until the EAC indication has been removed.

Alternatively, when the network has indicated to the WTRU that there is a limit to how many PDU Sessions the WTRU may establish in a slice, the WTRU may behave differently when evaluating URSP Rules. For example, if the back-off timer that is associated with the WTRU's PDU Session Limit for the Slice indication is still running and/or the restriction has not been removed, the WTRU may consider all RSD that include the S-NSSAI to be invalid if the RSD does not match an existing PDU Session and if the number of PDU Session(s) that the WTRU has established in the slice has reached the maximum value that was indicated by the network. The WTRU may consider this restriction to be in place until the back-off timer expires or the restriction has been removed.

As described above, the WTRU may be registered to a slice by not utilizing the resources of the slice beyond what is necessary to maintain the NAS connection and registration with the AMF.

The NSACF may detect that the WTRU has been registered to the slice for a relatively long time but has not established a PDU Session. In such a scenario, the NSACF may trigger (e.g., send a message when this happens, or may establish such a rule prior to this happening) the AMF to deregister the WTRU from the slice and provide the WTRU with a different slice that may be used instead (e.g., a less important slice, lower priority, or a slice not subject to NSAC).

The example flow that was illustrated in FIG. 2 may also be used use to describe how to configure the WTRU with a Replacement S-NSSAI that is currently being underutilized by the WTRU. This example is as follows.

At 201, the AMF may receive a notification from the NSACF that a WTRU is registered to a slice (e.g., identified by an S-NSSAI) but has not established a PDU Session in a relatively long period of time. This notification may include a Replacement S-NSSAI.

At 202a, the WTRU sends a Registration Request to the AMF. For example, this registration request may be a Mobility Registration Update. The AMF may detect that the S-NSSAI that was identified at 1 has been underutilized by the WTRU in the WTRU's Requested NSSAI. In addition to the NSACF notification, the AMF may consider any of: a registration quota threshold (e.g., configured/enabled per slice), and/or whether the WTRU has a PDU Session (e.g., unused) for that slice before initiating the logic for handling unused/underutilized slice for the WTRU.

At 203a, the AMF may send a Registration Accept message to the WTRU. The Registration Accept message includes the Replacement S-NSSAI in the Allowed NSSAI. The Registration Accept Message also indicates to the WTRU that the S-NSSAI has been replaced with the Replacement S-NSSAI. The Replacement S-NSSAI might not be in the WTRU's Configured NSSAI, however, the indication from the network may be interpreted by the WTRU as an indication that the WTRU can consider the Replacement S-NSSAI to be equivalent to the S-NSSAI in the current PLMN. If the WTRU has existing PDU Sessions in the S-NSSAI, the WTRU may consider the PDU Sessions to be terminated. In response to the slice being replaced, the WTRU may remove the slice that was replaced from its Configured NSSAI or mark it as inaccessible for a time. Alternatively, the AMF may send in the Registration Accept for an Allowed NSSAI that excludes the unused/underutilized slice with an indication/cause of “unused/underutilized slice”, and/or a timer controlling when the WTRU may attempt to re-register for that slice.

At 202b, the AMF may detect that the S-NSSAI that was identified at 1 as having been underutilized by the WTRU in the WTRU's Allowed NSSAI.

At 203b, the AMF may send a WTRU Configuration Update message to the WTRU. The WTRU Configuration Update message includes the Replacement S-NSSAI in the Allowed NSSAI. The WTRU Configuration Update message may also indicate to the WTRU that the S-NSSAI has been replaced with the Replacement S-NSSAI. The Replacement S-NSSAI may not be in the WTRU's Configured NSSAI, however, the indication from the network may be interpreted by the WTRU as an indication that the WTRU can consider the Replacement S-NSSAI to be equivalent to the S-NSSAI in the current PLMN. If the WTRU has more than one PDU Session in the S-NSSAI, the WTRU may consider the PDU Sessions to be terminated and the WTRU may attempt to establish new PDU Sessions with the Replacement S-NSSAI. If a re-registration timer for the unused/underutilized slice was provided, the WTRU may not attempt to re-register until timer expiry.

Note that the Replacement S-NSSAI that is associated with an S-NSSAI may be encoded as an S-NSSAI information element.

At 204, the restriction against registering to the S-NSSAI may be cleared and the WTRU's association with the Replacement NSSAI may be cleared by repeating 201-203 above without the Replacement S-NSSAI.

When the WTRU Deregisters, the WTRU may delete the information about the Replacement S-NSSAI.

An RSD of a URSP rule may include an S-NSSAI replacement trigger flag. The S-NSSAI replacement trigger flag may indicate to the WTRU that under certain conditions, the WTRU may replace the S-NSSAI that is in the RSD with a Replacement S-NSSAI. The conditions that trigger the WTRU to perform replacement may be a UAC broadcast indication that indicates that the S-NSSAI is barred, an indication from the AMF that EAC is active for the S-NSSAI, or the case where the WTRU previously attempted to establish a PDU Session towards the slice and the back-off timer that is associated with the rejection is still running.

A benefit of providing a replacement S-NSSAI to the WTRU is that the network can avoid updating all of the configured NSSAI, Allowed NSSAI, and URSP Rules if the network wants the WTRU to select a different slice.

In another example, a WTRU may implement a slice(s) inactivity tracking, such as where the WTRU may proactively track activity/usage of the slice(s), and if there is no activity/usage for a predetermined time, then the WTRU will deregister itself from those slices.

After successfully registering with the core network, a WTRU may have received the list of allowed NSSAI, along with the negotiated value for a slice inactivity timer. The slice inactivity timer duration may be mutually agreed/negotiated between the WTRU and the network (e.g., 5G core network) via NAS signaling.

A slice inactivity timer may track inactivity per slice present in the allowed NSSAI, such as if the slice has been registered with the core network, however, there has been no PDU session established for it or PDU session has been established without any data activity for the slice inactivity duration.

A slice inactivity timer may be started per allowed S-NSSAI, in order to track activity per individual slices. If there has been no activity for a slice (S-NSSAI), WTRU may deregister itself from that slice by triggering a NAS signaling procedure (e.g., Mobility Registration Request) excluding the inactive slice (S-NSSAI) from the requested NSSAI. This way, the WTRU may be able to proactively exclude slices (S-NSSAI) which had no PDU session established or no data activity for the slice inactivity duration.

In some cases, a PDU session may be selectively transferred.

A WTRU may provide assistance information to help the network (e.g., a functional node, WTRU acting as a relay, a base station, AMF, SMF, etc.) predict traffic activity on a PDU Session, by using the concept of NAS-Release Assistance Information (NAS-RAI). For example, NAS-RAI may indicate that no Uplink or Downlink Data transmission is expected for a period of time on the relevant PDU Session. The network, such as the SMF, may use this information to determine priority on what PDU Session could be transferred to another network slice or could be torn down. A network function, such as the AMF or SMF, may use this information isolated or in combination with Slice Load and WTRU specific analytics as those described herein when determining what PDU Session could be transferred to another network slice or could be torn down. In addition, the network may use this information to determine the duration of a back-off timer given to the WTRU to control admission to network slice. In addition, the network may provide the WTRU with a prediction of when the PDU Session is likely to be torn down (e.g., in the form of a grace period) based on the EAC and/or P-EAC.

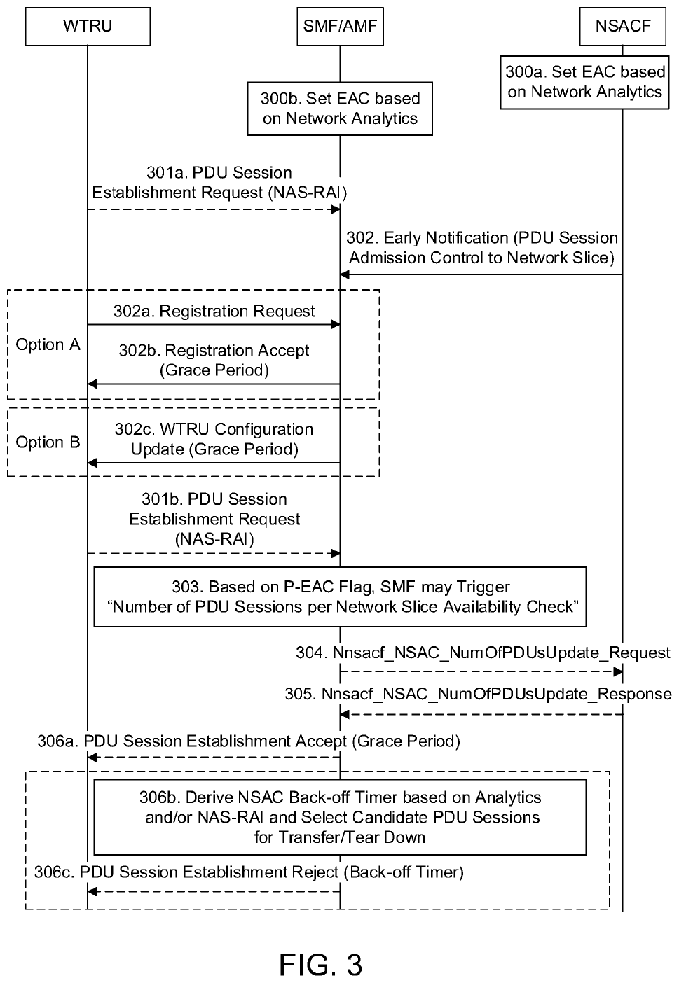

A WTRU may use the NAS-Release information on every PDU Session Establishment Request of Modification, or only after the WTRU has been notified by the network that EAC or P-EAC is likely to be reached. FIG. 3 provides an example of a call flow as to how this mechanism may be used, as explained in further detail herein.

An RAI indication may be an Access Stratum indication that is included by the WTRU when sending data to the network. The RAI may be an Access Stratum indication that indicates to the base station that no subsequent uplink or downlink data transmission (e.g., an acknowledgement or response from the application server) is expected, thus the base station may release the WTRU's RRC Connection. This may be communicated to the AMF through an N2 WTRU Context Release Request. The AMF may indicate to the SMF that the PDU Session is not expected to see activity for a relatively long time and the SMF may use this indication to determine to release the PDU Session.

In addition, the WTRU may include the NAS-RAI (Non-Access Stratum indication) that indicates to the AMF that no subsequent uplink or down data transmission is expected for such a long time that it is permissible to release the PDU Session. The AMF may indicate to the SMF that the PDU Session is not expected to see activity for a relatively long time and the SMF may use this indication to determine to release the PDU Session. Alternatively, the SMF may deactivate the PDU Session once there is no further downlink data, using the NAS-RAI indication, and therefore this PDU will not count towards the maximum number of PDU Session in the slice. The SMF may update the NSACF using the decrease flag.

FIG. 3 illustrates an example of a WTRU assisted PDU Session Early Admission Control. In the example procedure of FIG. 3., the network provides a grace period to the WTRU. The network may provide a grace period to the WTRU in response to a Registration Request from the WTRU. For example, the network may choose to wait to send the grace period to the WTRU until the WTRU enters connected mode by sending a registration request. Alternatively, the network may send the grace period to the WTRU by sending a WTRU Configuration Update message to the WTRU. For example, the network may choose to send the WTRU Configuration Update message to the WTRU if the WTRU is already in connected mode or the network may choose to initiate a paging procedure for the WTRU if the WTRU is in idle mode so that the network can send the WTRU Configuration Update message to the WTRU. These different example scenarios are shown as different options in the figure.

At 300a and/or 300b, the NSACF and/or other network function involved in the EAC procedure (e.g., the AMF or SMF) may derive Early Admission Control Thresholds based on Network Analytics (e.g., WTRU related analytics and/or Network Slicing Analytics, and/or any analytics described herein)

At 301a (e.g., conditional), a WTRU may request the establishment of a PDU Session, and it may provide NAS Release Assistance Information from the outset.

At 302, the NSACF may send an Early Admission Control Notification to the SMF, causing the SMF to set the P-EAC flag

At 302a (e.g., conditional), the WTRU may issue a Registration Request (e.g., mobility registration).

At 302b (e.g., conditional), the AMF may provide the WTRU with a grace period, derived from Network Analytics and possibly from the NAS-RAI sent by the WTRU. In some instances, the grace period may be a time value indicating when a PDU Session will be released if the network detects no activity on the PDU Session.

At 302c (e.g., conditional), the AMF may provide the WTRU with a grace period, derived from Network Analytics and possibly the NAS-RAI sent by the WTRU, using a message (e.g., UE Configuration Update (UCU) command).

At 301b (e.g., conditional), the WTRU may request the establishment of a PDU Session, and it may provide NAS Release Assistance Information based on the information received on the UCU or Registration accept message.

At 303, the SMF may trigger a number of PDU Sessions per network slice check, prior to accepting the PDU Session Establishment request.

At 304 and 305, the NSACF may indicate whether the limit has been reached or not.

At 306a (e.g., conditional), the SMF may accept the establishment of the PDU Session requested by the WTRU if the number of PDU Sessions per slice has not been reached. The SMF may send to the WTRU a prediction as to when the limit on the number of PDU Sessions per network slice may be reached, such as a grace period in the form of a timer, indicating an estimate as to when this limit may be reached, based on network analytics as those described herein.

At 306b (e.g. conditional) (e.g., assuming that 306a accept does not occur), the SMF may derive a back-off timer value. The value may be based on analytics information that is obtained from the Network Data Analytics Function (NWDAF) and the NAS-RAI that is received from the WTRU.

At 306c (e.g., conditional), the SMF may reject the establishment of the PDU Session requested by the WTRU if the number of PDU Sessions per slice has been reached. The SMF may send a back-off timer to the WTRU indicating a prediction as to when new PDU Sessions can be requested, based on network analytics as those described in herein.

In one example, the WTRU may receive information indicating that a slice that the WTRU is registered to is restricted because the slice has reached a PDU Session Limit. When the WTRU evaluates URSP Rules, it may consider all RSDs that are associated with a slice that has been restricted to be invalid unless the RSD describes a PDU Session that has already been established. Later, the WTRU may detect that the restriction has been removed and no longer considers the restriction during URSP evaluation. The WTRU may detect/determine that the restriction is removed based on a message from the network or upon expiry of a timer.

In one example, the WTRU may receive information indicating that a slice is restricted because the slice has reached a maximum number of WTRUs. The WTRU may receive a replacement slice name (e.g., Replacement S-NSSAI), terminate PDU Sessions that are associated with the restricted slice, register with the replacement slice, and/or establish PDU sessions in the replacement slice. When the WTRU evaluates URSP Rules, it may consider the restricted S-NSSAI to be equivalent to the Replacement S-NSSAI. Later, the WTRU may detect/determine that the restriction has been removed and no longer considers the restriction during URSP evaluation. The WTRU may detect/determine that the restriction is removed based on a message from the network or upon expiry of a timer.

In some instances, upon receiving a replacement slice, the WTRU may assume that the PDU session of that slice is terminated (e.g., no PDU session would exist until it is re-established).

In some instances, a WTRU may receive a set of replacement slices, and upon a trigger event occurring (e.g., as described herein), may transfer the PDU session to a replacement slice and discontinue the use of the existing slice.

In some instances, the WTRU may stop using the current slice immediately, or shortly thereafter, upon receiving an indication of an alternative/replacement slice and/or once a trigger event occurs. In some instances, the S-NSSAI may be considered to be a slice type and the slice ID is never seen by the WTRU. The slice ID may change without the WTRU knowing. When the alternative slice is received, the WTRU may (e.g., immediately, or soon) stop using the PDU Session that is associated with the current S-NSSAI and establish a new PDU Session with the Replacement S-NSSAI.

An RSD of a URSP rule may include an S-NSSAI replacement trigger flag. The S-NSSAI replacement trigger flag may indicate to the WTRU that under certain conditions, the WTRU may replace the S-NSSAI that is in the RSD with a Replacement S-NSSAI. The conditions that trigger the WTRU to perform replacement may be a UAC broadcast indication that indicates that he S-NSSAI is barred, an indication from the AMF that EAC is active for the S-NSSAI, and/or the case where the WTRU previously attempted to establish a PDU Session towards the slice and the back-off timer that is associated with the rejection is still running.

A benefit of providing a replacement S-NSSAI to the WTRU is that the network may avoid updating all of the configured NSSAI, Allowed NSSAI, and/or URSP Rules if the network wants the WTRU to select a different slice.

The NSACF may use network analytics such as WTRU information or Slice Congestion, to set threshold values for Network Slice Admission Control.

By extending the concept of Early Admission Control notification, the SMF/AMF may provide the WTRU an indication as to when a Slice has reached its limit regarding number of WTRUs or number of PDU Sessions.

The WTRU may provide assistance information to help the network, such as AMF or SMF, to predict traffic activity on a PDU Session by reusing the concept of NAS-Release Assistance Information.

The network, such as the SMF, may use the NAS-RAI to determine priority on what PDU Session could be transferred to another network slice or could be torn down. A network function, such as the AMF or SMF, may use this information isolated or in combination with Slice Load and WTRU specific analytics as those described herein when determining what PDU Session could be transferred to another network slice or could be torn down.

The network, such as the AMF or the SMF, may use NAS-RAI information to determine the duration of the back-off timer given to the WTRU to control admission to network slice. In addition, the AMF or/and the SMF may provide the WTRU with a prediction of when the PDU Session is likely to be torn down, for example in the form of a grace period, based on the EAC and/or P-EAC, for example in the form of a grace period.

The WTRU may use the NAS-Release information on every PDU Session Establishment Request of Modification, or only after the WTRU has been notified by the network that EAC or P-EAC is likely to be reached

In one example method, an AMF may receive a notification that a slice has reached its PDU Session Limit. The AMF may detect this limit after the WTRU(s) that are registered to the slice and a WTRU later sends a registration request which would be at or over the limit, or the AMF decides to proactively send a WTRU Configuration Update once the limit is reached, or before it is reached. The WTRU may receive an indication that the S-NSSAI has reached its PDU Session limit and an associated back-off timer. The indication signals to that the WTRU is barred from attempting to send a PDU Session Establishment Request for the slice until the associated back-off timer expires or until the restriction is cleared. Later, when a new application traffic starts, this indication influences URSP Rule evaluation (e.g., makes some RSDs invalid). The WTRU may receive an indication that the condition has been cleared.

In one example method, an AMF may receive a notification that a slice has reached its registration Limit. A WTRU may try to register to the slice or the AMF proactively sends a WTRU Configuration Update message to a WTRU that is registered to the slice. The WTRU may receive an indication that the S-NSSAI has reached its registration limit and Replacement S-NSSAI that the WTRU may use instead of the S-NSSAI. The WTRU may subsequently use this replacement slice in procedures such as PDU Session Establishment. The WTRU may receive an indication that the condition has been cleared and the WTRU may return to using the original S-NSSAI.

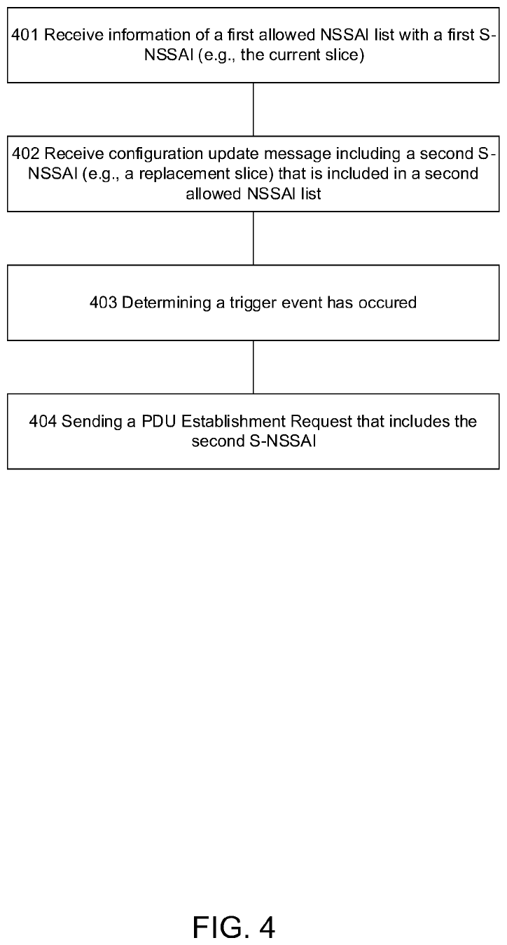

FIG. 4 illustrates an example of a replacement slice process. At 401, a WTRU may receive information including a first allowed network slice selection assistance information (NSSAI) list, wherein the allowed NSSAI list is associated with at least a first single-NSSAI (S-NSSAI). In some instances, the information that is received may further include one or more data network names (DNNs). At 402, the WTRU may receive a configuration update message that indicates a second S-NSSAI (e.g., a replacement slice) that is associated with a second allowed NSSAI list. The configuration update message may further indicate that the second S-NSSAI is associated with the first S-NSSAI, in that it is its replacement slice. At 403, the WTRU may determine that a trigger event has occurred, such as receiving a unified access control (UAC) broadcast, receiving an AMF indication, determining that a back-off timer has expired, and/or receiving the indication of the second S-NSSAI. At 405, the WTRU may send a Protocol Data Unit (PDU) session establishment request that includes the second S-NSSAI based on the trigger event. In some instances the PDU session establishment request includes a DNN from the one or more DNNs previously received. These exchanges may be between the WTRU and the network (e.g., AMF, SMF, base station, etc.). In some instances, there may be a PDU session that uses the first S-NSSAI initially, which may be terminated upon receiving the message that indicates the second S-NSSAI; further, a PDU session establishment request may be sent to replace the initial PDU session that was being used with the first S-NSSAI. In some instances, the WTRU may send a registration request for the slice before sending the PDU request. In some instances, the WTRU need not send a registration request; since the network added the replacement slice to the Allowed NSSAI, then means WTRU has been registered to the slice without the WTRU requesting registration.

As described herein, all embodiments and examples are intended to be combinable, meaning, that a step or feature from one example may be optionally used in another example's process. Further, all aspects of embodiments and examples disclosed herein may be optional.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-14. (canceled)

15. A method implemented by a wireless transmit receive unit (WTRU), the method comprising:
receiving a message from an AMF of a network, the message including an allowed Network Slice Selection Assistance Information (NSSAI), wherein the message is a registration accept message or a configuration update message, wherein a replacement Single-NSSAI (S-NSSAI) is part of the allowed NSSAI, wherein the message includes an indication that the replacement S-NSSAI is a replacement for a second S-NSSAI; and
sending a request for PDU session establishment to the network, wherein the request includes the replacement S-NSSAI.

16. The method of claim 15 wherein the message includes a mapping for a list of a plurality of replacement S-NSSAI, wherein the mapping includes the replacement S-NSSAI and the current S-NSSAI.

17. The method of claim 15 further comprising a sending registration message, prior to receiving the message, related to the second S-NSSAI.

18. The method of claim 15 further comprising evaluating UE Route Selection Policy (URSP) rules, and considering the second S-NSSAI to be equivalent to the replacement S-NSSAI while evaluating the URSP rules.

19. The method of claim 18, wherein evaluating URSP rules results in determining a third S-NSSAI.

20. The method of claim 18, wherein evaluating URSP rules results in determining to send the PDU session establishment to the network.

21. The method of claim 19 wherein the third S-NSSAI is the replacement S-NSSAI.

22. A wireless transmit receive unit (WTRU), the WTRU comprising:
a processor operatively coupled to a receiver, the processor and receiver configured to receive a message from an AMF of a network, the message including an allowed Network Slice Selection Assistance Information (NSSAI), wherein the message is a registration accept message or a configuration update message, wherein a replacement Single-NSSAI (S-NSSAI) is part of the allowed NSSAI, wherein the message includes an indication that the replacement S-NSSAI is a replacement for a second S-NSSAI; and
a processor operatively coupled to a transmitter, the processor and transmitter configured to send a request for PDU session establishment to the network, wherein the request includes the replacement S-NSSAI.

23. The WTRU of claim 22, wherein the message includes a mapping for a list of a plurality of replacement S-NSSAI, wherein the mapping includes the replacement S-NSSAI and the current S-NSSAI.

24. The WTRU of claim 22, wherein the processor and transmitter configured to send a registration message, prior to receiving the message, related to the second S-NSSAI.

25. The WTRU of claim 22, wherein the processor configured to evaluate UE Route Selection Policy (URSP) rules, and considering the second S-NSSAI to be equivalent to the replacement S-NSSAI while evaluating the URSP rules.

26. The WTRU of claim 25, wherein evaluating URSP rules results in determining a third S-NSSAI.

27. The WTRU of claim 25, wherein evaluating URSP rules results in determining to send the PDU session establishment to the network.

28. The method of claim 26 wherein the third S-NSSAI is the replacement S-NSSAI.
